(19) United States
(12) Patent Application Publication
(10) Pub. No.: US 2003/0180487 A1
(43) Pub. Date: Sep. 25, 2003

(54) Non-foil barrier laminates

(76) Inventors: Tricia Susan Reighard, Loveland, OH (US); Alexander Craig Bushman, Loveland, OH (US); James Irvin Marchman, Cincinnati, OH (US)

Correspondence Address: Cummings & Lockwood, Four Stamford Plaza, P. O. Box 120, Stamford, CT, 06904-0120, US

(21) Appl. No.: 10/105,713

(22) Filed: Mar. 25, 2002

(51) Int. Cl. B32B 1/02

(52) U.S. Cl. 428/34.2; 428/532; 428/481

(57) ABSTRACT

A non-foil barrier laminate structure is provided that results in an improvement in shelf life performance of packaged food products over existing non-foil barrier laminates. Containers constructed from the barrier laminates of the invention can be hot filled or cold filled and can be stored at either ambient conditions or refrigerated conditions. The laminate structures have a polyamide layer for mechanical strength and thermal resistance; at least one EVOH layer as a barrier to oxygen ingress applied either in direct contact with the polyamide layer or separated therefrom by at least one tie layer; an optional second functional barrier layer positioned closer to the product's contact surface that may act as a barrier to oxygen, water vapor, flavor/aroma, or a combination; and layers of polyolefin on both the matte side (interior) and the gloss side (exterior) of the laminate for heat sealing.

### BACKGROUND OF THE INVENTION

This invention relates to non-foil barrier laminate structures for food packaging. The barrier structures of the present invention may be used in a variety of packages, including paper cartons, cups, canisters, pouches, plastic bottles, bags and the like. The barrier structures are heat sealable, thus providing for facile conversion of the barrier structure into cartons and similar packages, which require heat sealing. The barrier structures of the present invention are particularly useful in packaging beverages, fruit juices and citrus juices and in particular orange juice. The non-foil barrier laminates have excellent oxygen barrier characteristics as well as the ability to protect the products therein against vitamin C degradation, flavor loss, browning and microbial growth.

Paperboard coated with low density polyethylene (LDPE) has been used to make beverage containers, but falls short in providing an acceptable container for some products such as fruit juices. In particular, paperboard coated with LDPE has a relatively high permeability to oxygen, which may lead to loss of flavor components and vitamins through oxidation. Flavor loss can also occur as a result of migration or uptake of flavor components into the LDPE layer, a process referred to as “scalping.” Additional barrier materials to oxygen and flavor components have therefore been investigated to achieve the desired goal.

The oxidative loss of vitamin C can be substantially reduced by the use of a laminate containing a metal foil as an oxygen barrier along the interior of the container. However, the economics involved in using a metal foil often require a price premium that limits profitability. A search for economically acceptable alternatives to foil has resulted in the development of laminate structures utilizing coextruded polymer materials such as polypropylene, polyethylene terephthalate (PET), polyvinylidene chloride (PVdC) and ethylene vinyl alcohol copolymer (EVOH) as the barrier material. See, for example Tanner U.S. Pat. No. 4,988,546, Gibbons et al. U.S. Pat. Nos. 4,789,575 and 4,701,360, Thompson et al. U.S. Pat. No. 4,513,036, and Huffman U.S. Pat. No. 5,059,459.

Polyamides (nylons) have also been proposed and used commercially as barrier layers in plastic packaging materials; see, for example, Thompson U.S. Pat. Nos. 4,777,088 and 4,835,025, Gibbons U.S. Pat. No. 4,983,431, Wright U.S. Pat. No. 5,324,528, Parks U.S. Pat. No. 6,193,827, and Brown U.S. Pat. No. 4,753,832.

In addition to being less expensive than foil-containing structures, paperboard laminates containing barrier materials as afore disclosed have been found to exhibit lower flavor loss by using less LDPE as the product contact layer. Commercial structures for a paperboard carton for juice and similar products now frequently utilize a laminate containing either nylon or ethylene vinyl alcohol copolymer as a barrier to oxygen and flavor oils.

Gibbons et al. U.S. Pat. No. 4,921,733 discloses various Nylon 6, Nylon 66, Nylon 11, Nylon 12 polymers and the like, having tensile strength of 10,000 psi or more, as abuse-resistant layers for use in combination with a caulking adhesive tie polymer such as a Surlyn ionomer or an ethylene methacrylic acid polymer resin and an oxygen barrier such as aluminum foil for paperboard containers.

Kinsey U.S. Pat. No. 6,110,548 discloses an extended long life non-foil juice carton constructed of an abuse-resistant nylon layer, a caulking layer consisting of adhesive tie and polyolefin materials, a layer of high barrier ethylene vinyl alcohol copolymer (27-32 mole % ethylene content) to prevent scalping of flavor oils and provide a low permeability oxygen barrier, and a thin layer of adhesive tie and polyolefin materials coated over the ethylene vinyl alcohol copolymer layer for heat sealing.

It is an object of the present invention to provide an improved, heat-sealable barrier laminate material for use in a variety of food packaging.

Still another object of the invention is to provide an improved heat sealable barrier laminate material for a juice carton which does not scalp flavor/aroma ingredients of citrus and other juices, exhibits a substantial barrier to the loss of vitamin C, and has performance equal to or better than that of conventionally used polymer barrier laminates.

It is a further object of the invention to provide a heat sealable laminate material having a low oxygen permeability during filling over a range of temperatures (hot fill to cold fill) and at both room temperature and refrigerated storage conditions.

Still a further object of the invention is to provide improved heat sealable, non-foil laminates for fruit or citrus juices, beverages and the like, as well as non-liquid dry products, which are easy to manufacture, which provide reliable performance in the field, including a high degree of flavor, color and vitamin protection across the product's shelf life.

In accordance with the invention, the barrier laminates include a substrate, a polyamide layer primarily for mechanical strength and thermal resistance applied to the inner surface of the substrate, an ethylene vinyl copolymer as an oxygen barrier which is provided in proximity to the polyamide layer, an optional second layer of ethylene vinyl alcohol copolymer, nylon, or the like that serves as a barrier to oxygen, water vapor, or flavor/aroma components, a polyolefin product contact layer, such as low density polyethylene, which is provided on the interior surface (matte surface) of the laminate and serves for heat sealing, and a polyolefin layer, such as low density polyethylene, which is provided on the exterior surface (gloss surface) of the laminate.

Traditionally, fruit juices packed in cartons, particularly gable top cartons, have been kept refrigerated throughout the distribution process in order to avoid rapid spoilage due to microbial growth. Microbial growth can result from incomplete sterility of the product, carton, or filling system. It is only with continual refrigeration to retard microbial growth that a typical shelf life of several weeks can be assured. As a result, products packed in this way are not said to be shelf stable.

Shelf stability of packaged fruit juices is extremely desirable from many standpoints. A shelf stable product is much less likely to spoil while in the distribution system and with a shelf life measured in months rather than days, losses due to spoilage should be low. The packer does not need to maintain the product under refrigeration either in its warehouse or while in transport. Similarly the retailer need not allocate expensive refrigerated space to store its supply of product. The consumer also has the advantage of a product which does not require refrigeration until opened.

Processes and apparatus for packaging perishable liquid food products and in particular juices are described in U.S. Pat. Nos. 5,555,702 and 5,421,512. The entirety of these patents is incorporated herein by reference.

Hot fill processes such as are disclosed in the aforenoted patents, are useful for acidic products (pH of 4.5 or less) such as fruit juices, punches, and drinks. The product is heated to a temperature not exceeding approximately 190° F. to inhibit microbiological activity before filling hot into the package. The package is then cooled to <100° F. within 20-30 minutes to preserve maximum flavor and color integrity. As the product cools, a partial vacuum is created on the package. The resulting package can be stored at room temperature for extended periods of time (often 3 months or longer) without compromise of product quality.

Loss of product quality (i.e., microbial growth, browning, degradation of vitamins, or flavor loss) is dictated primarily by rate of oxygen ingress into the package. Hot fill gable top cartons have historically been constructed using aluminum foil because it is an excellent oxygen barrier. However, foil is susceptible to cracking (particularly in the score areas), is expensive, and is difficult to recycle in many regions of the world. The development of a non-foil alternative would potentially overcome these shortcomings.

Fresh juices are generally filled into packages at cold temperatures, sealed, and stored cold throughout the distribution chain. However, at times and in some parts of the world, breaks in the refrigerated distribution chain occur and loss of product quality (i.e. microbial growth, browning, degradation of vitamins, or flavor loss) is experienced.

Fresh juices that are filled into packages at cold temperatures and stored at optimum refrigerated conditions throughout the package shelf life often still show a loss in product quality as the product ages. This is demonstrated by vitamin C degradation, flavor loss, browning and in some cases, microbial growth. The development of a superior non-foil package structure for fresh juices that are cold filled and stored cold is also within the scope of the invention.

### SUMMARY OF THE INVENTION

In accordance with the invention, there are provided non-foil laminates for liquid and non-liquid (dry) products, preferably for fruit or citrus juices, beverages and the like, which are easy to manufacture and provide reliable performance in the field which comprise a multi-layer polymer structure including a nylon abuse resistance layer applied to the inner surface of a paperboard substrate and at least one layer of an ethylene vinyl alcohol copolymer (“EVOH”) oxygen barrier. The EVOH layer is located in the interior of the laminate, either directly after the nylon layer or separated from the nylon layer by tie layers. It is possible to have two EVOH layers, but the second EVOH layer must be separated from the first EVOH layer by at least one polymer layer.

### BRIEF DESCRIPTION OF THE FIGURES

FIG. 1 is a cross-sectional elevation of a preferred embodiment of the laminate of the present invention.

FIG. 2 is a cross-sectional elevation of a second preferred embodiment of the laminate of the present invention.

FIG. 3 is a graphic representation of % vitamin C retained vs. days after filling for cartons that were hot filled with orange juice and stored at 73° F. for 85 days.

FIG. 4 is a graphic representation of % vitamin C retained vs. days after filling for cartons that were cold filled with orange juice and stored at 73° F. for 64 days.

FIG. 5 is a graphic representation of % vitamin C retained vs. days after filling for cartons that were cold filled with orange juice and stored at 38° F. for 64 days.

FIG. 6 is a graphic representation of % vitamin C retained vs. days after filling for cartons that were hot filled with orange juice and stored at 73° F. for 69 days.

FIG. 7 is a graphic representation of % vitamin C retained vs. days after filling for cartons that were cold filled with orange juice and stored at 73° F. for 56 days.

FIG. 8 is a graphic representation of % vitamin C retained vs. days after filling for cartons that were cold filled with orange juice and stored at 38° F. for 63 days.

### DETAILED DESCRIPTION OF THE PREFERRED EMBODIMENTS OF THE INVENTION

Two non-foil coextruded laminate structures were prepared suitable for use in hot fill or cold fill applications. All weights are expressed in pounds per 3000 square feet.

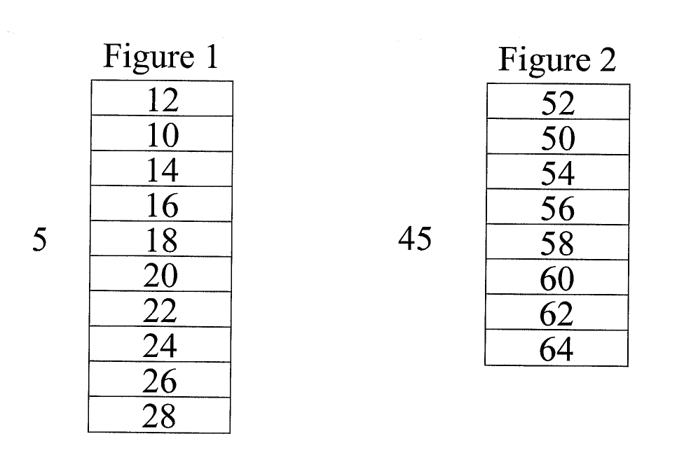

Referring to FIG. 1, the structure 5 contains a paperboard substrate 10 (100-300 lbs.) onto which there is applied on one side an extrusion coating of polyolefin polymer layer 12 such as low density polyethylene at a coating weight of 5-20 lbs. and preferably about 12 lbs. to provide the outer surface of the laminate.

Layer 12 is the outer “gloss” layer. Preferably, the polyolefin polymer is polyethylene and most preferably, a low density polyethylene. Typical of the preferred low density polyethylenes which can be employed in layer 12 are Tenite 1924P polyethylene available from Eastman Chemical Co., Kingsport, Tenn. and Chevron 4517 available from Chevron Phillips Chemical Co., Houston, Tex.

On the interior of the substrate 10, there is applied a polyamide layer 14 (1-20 lbs. and preferably about 5 lbs.). The polyamide polymer layer can be, but is not limited to, nylon 6, nylon 66, nylon 10, nylon 6-10, nylon 12, amorphous nylons, nylon nanocomposites, and other suitable polyamides. One appropriate nylon 6 material is Honeywell B73QP. Onto the inner surface of layer 14 there is applied an oxygen barrier layer of ethylene vinyl alcohol copolymer 16 having a coating weight of between 0.5-10 lbs. and preferably approximately 3-6 lbs. The ethylene vinyl alcohol copolymer layer may contain 27-44 mole % ethylene. Layer 16 can also be, but is not limited to, oxygen scavenging EVOH materials such as those under development by Nippon Gohsei or Kuraray, EVOH nanocomposites, or blends of EVOH with polyolefins such as low density polyethylene. A preferred ethylene vinyl alcohol copolymer is sold under the product name Soarnol D2908 resin and is available from Soarus LLP.

There is then applied to the underside of the ethylene vinyl alcohol copolymer layer 16, a tie layer 18 (0.5-15 lbs. and preferably about 8 lbs.) preferably based on, but not limited to, ethylene-based copolymers modified with maleic anhydride functional groups such as Plexar 5125 produced by MSI Technologies.

A polyolefin layer 20 is applied to the underside of the tie layer 18 and has a coating weight of 1-20 lbs. and preferably about 4-10 lbs. A second tie layer 22 (1-5 lbs., preferably approximately 1.5 lbs.) is applied onto layer 20. Another barrier layer preferably EVOH, (1-10 lbs., and preferably about 3 lbs.) 24 is applied to the interior of layer 22. Layer 24 can be, but is not limited to, ethylene vinyl alcohol copolymers (containing 27-44 mole % ethylene), oxygen scavenging EVOH materials, EVOH nanocomposites, EVOH combined with other inorganic fillers (such as talc or kaolin), or blends of EVOH with other polymers (such that EVOH remains the continuous phase); polyvinyl alcohols (PVOH); polyamides such as, but not limited to, nylon 6, nylon 66, nylon 10, nylon 6-10, nylon 12, amorphous nylons, nylon nanocomposites, nylon combined with other inorganic fillers (such as talc or kaolin), and blends of nylon with other polymers (such that the nylon remains the continuous phase); polyester terephthalates including glycol-modified polyethylene terephthalates, acid-modified terephthalates, PET nanocomposites, PET combined with other inorganic fillers (such as talc or kaolin), and blends of PET with other polymers (such that the PET remains the continuous phase); or polyolefins including, but not limited to, low density polyethylene, high density polyethylene, linear low density polyethylene, polypropylene, cyclic olefin copolymers, and blends thereof; polycarbonates; and liquid crystal polymers. In addition, desiccants, molecular sieves, and the like may be added to layer 24 to improve water vapor barrier characteristics of the layer; and molecular sieves, cyclodextrins, and the like may be added to same layer for improved flavor/aroma barrier. To layer 24 is applied a third tie layer 26 (1-5 lbs., preferably about 1.5 lbs.) followed by a polyolefin polymer layer 28 forming the product contact surface. Layer 28 has a coating weight of 1-20 lbs. and preferably approximately 4-10 lbs.

The polyamide polymer layer 14 is provided mostly for mechanical strength and thermal resistance to improve the overall distribution abuse resistance and bulge resistance of the laminate 5. The EVOH layer 16 serves as a barrier to oxygen ingress much as the aluminum foil layer does in traditional hot fill structures. The polyolefin layer 20 along with the tie layer 18 serves the same function as a caulking layer that melts to some extent in subsequent heating steps, filling channels that form when the laminate is folded and heated sealed to form a carton. The layer 24 may act as a barrier to oxygen, water vapor, or aromas/flavors depending on the materials selection. In the preferred embodiment, layers 26 and 28 are relatively thin as a means of minimizing the loss of flavor oils. The presence of an aroma/flavor barrier in layer 24 further minimizes flavor oil loss. In addition, by providing layers 26 and 28, the side seams of packages produced with the laminate 5 can be skived since the polyolefin polymer can be heat sealed to itself and to the gloss layer 12. The polyolefin can be, but is not limited to, low density polyethylene, linear low density polyethylene, high density polyethylene, polypropylene, copolymers, and blends thereof.

Referring to FIG. 2, a second preferred structure 45 consists of a paperboard substrate 50 (100-300 lbs.) to which is applied on one side a coating of polyolefin polymer layer 52 such as low density polyethylene at a coating weight of 5-20 lbs. and preferably about 12 lbs. There is then applied to the other side of the substrate 50, a polyamide layer 54 (1-20 lbs. and preferably about 5 lbs.) followed by a tie layer 56 (0.520 lbs., preferably approximately 10-15 lbs.). To the underside of layer 56 is applied another tie layer 58 (1-10 lbs., preferably about 4 lbs.). An oxygen barrier layer of ethylene vinyl alcohol copolymer 60 having a coating weight of between 1-10 lbs. and preferably about 3-6 lbs. is added onto the interior of layer 58. A third tie layer 62 (1-10 lbs., preferably about 4 lbs.) is followed by a polyolefin layer 64 (1-40 lbs., preferably about 22-30 lbs.). All of the materials specified in laminate structure 5 can also be used in structure 45.

Referring to laminate 5 in FIG. 1, the polyolefin polymer layer 12 is extrusion coated onto the substrate 10. The polyamide 14, ethylene vinyl alcohol copolymer 16, and tie layer 18 are then deposited as a coextrusion on the uncoated side of substrate 10. The polyolefin layer 20, tie layer 22, barrier layer 24, tie layer 26, and polyolefin layer 28 are then produced as a coextrusion and coated onto the first coextrusion, yielding laminate 5. While this is one method of forming the laminate 5, other methods can be employed to result in the same final structure.

Referring to laminate 45 in FIG. 2, the polyolefin polymer layer 52 is coated onto the substrate 50. The polyamide layer 54 and tie layer 56 are put down as a coextrusion coating onto the uncoated side of substrate 50. Tie layer 58, ethylene vinyl alcohol copolymer layer 60, and tie layer 62 are then applied as a coextrusion coating over the first coextruded layers. Finally, the polyolefin layer 64 is extruded over the second coextrusion, forming the laminate 45. While this is one method of forming the laminate 45, other methods can be employed to result in the same final structure. For example, the tie layers 56 and 58 could be combined provided that the functionality of the individual layers is retained.

The following examples are provided for further illustrating the invention, but are not to be construed as limitation thereof.

### EXAMPLE 1

A non-foil hot fill structure (described as “NFHF”) consistent with the format of laminate 5 in FIG. 1 was produced using 5 lbs. amorphous nylon in layer 14, 6 lbs. ethylene vinyl alcohol copolymer in layer 16, and 5 lbs. amorphous nylon in layer 24. No difficulties were encountered during extrusion coating or converting into skived liter gable top cartons. The cartons were then hot filled with orange juice from concentrate that was processed at 190° F. A commercially available hot fill foil carton (“Foil”), a commercially available non-foil barrier carton for cold filled products (“NFCF”), and a nylon barrier carton typically used for cold filled products (“nylon”) were also hot filled under the same conditions. The foil carton contains a thick LDPE layer (about 33 lbs.) over the foil barrier layer on the product contact side of the carton. The NFCF carton structure is consistent with the laminate defined in Kinsey U.S. Pat. No. 6,110,548. The nylon laminate was produced using 12 lbs. amorphous nylon applied to the paperboard followed by 1.5 lbs. adhesive tie, and 22 lbs. LDPE as the product contact layer. The filled cartons were stored at ambient conditions (73° F.) throughout the shelf life evaluation.

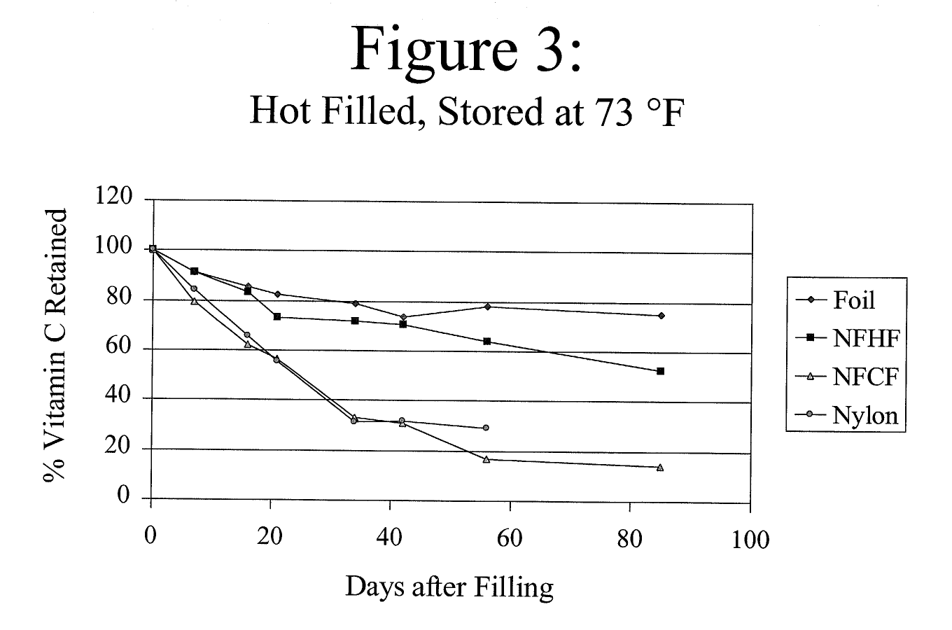

Vitamin C content was measured during filling and subsequently at days 7, 16, 21, 34, 42, 56 and 85 after filling. A plot of % vitamin C retained vs. days after filling is shown in FIG. 3. The experimental non-foil hot fill (NFHF) carton is nearly equivalent to foil in terms of vitamin C retention through six weeks shelf life but ended 22% lower than foil after 85 days. Vitamin C retention of the existing NFCF structure was 38% poorer than the NFHF carton and 60% poorer than the foil control. The nylon laminate also performed poorly, nearly matching the NFCF structure.

### EXAMPLE 2

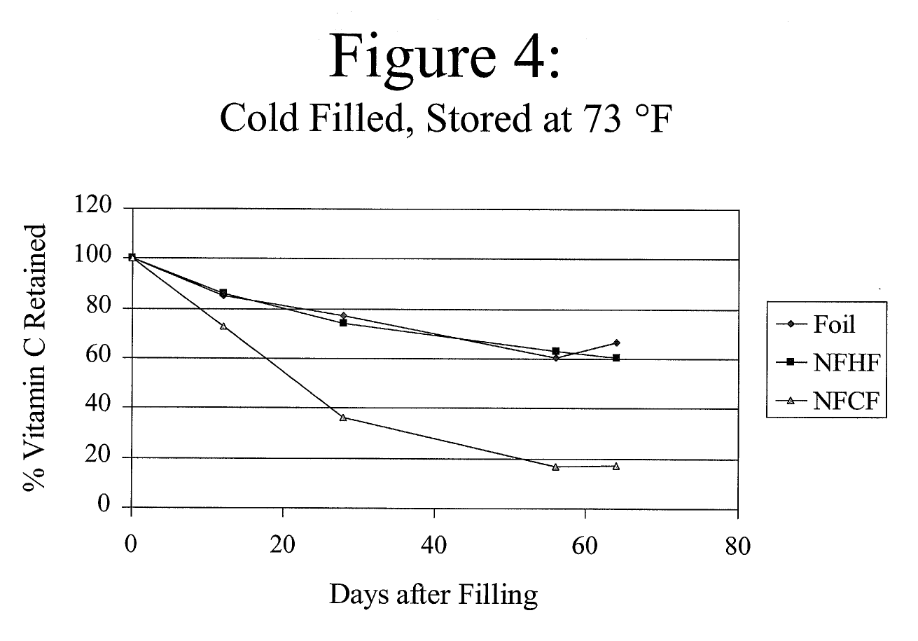

The NFHF, NFCF, and foil cartons used in Example 1 were also cold filled with fresh orange juice and stored at room temperature for 64 days. Vitamin C content was measured during filling and at days 12, 28, 56 and 64 after filling. A plot of % vitamin C retained vs. days after filling is shown in FIG. 4. In this example, the experimental non-foil hot fill (NFHF) structure performed equivalently to the foil control across the 64 day shelf life test. Performance of the existing non-foil structure for cold filled (NFCF) applications was again significantly poorer with a 46% greater loss in vitamin C compared to foil and NFHF.

### EXAMPLE 3

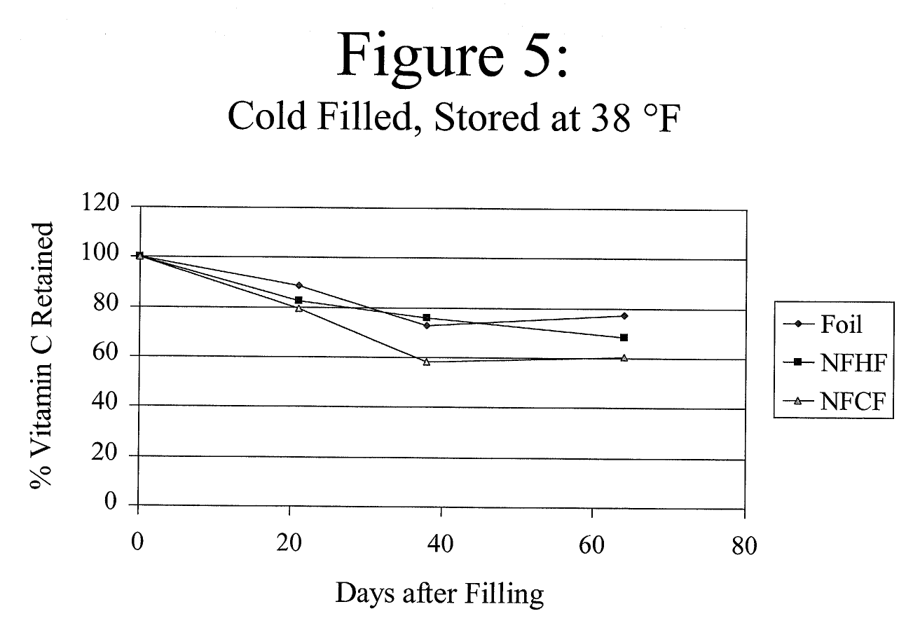

Cartons identical to the three carton structures of Example 2 were also cold filled with fresh orange juice and stored at refrigerated conditions (38° F.) for 64 days. Vitamin C content was measured during filling and at days 21, 38 and 64 after filling. A plot of % vitamin C retained vs. days after filling is shown in FIG. 5. In this example, the experimental non-foil hot fill (NFHF) structure performed at a level that was 9% poorer than the foil carton but 8% better than the NFCF carton.

### EXAMPLE 4

A structure (NFHF A) consistent with the format of laminate 5 of FIG. 1 was produced using 5 lbs. nylon 6 in layer 14, 3 lbs. ethylene vinyl alcohol copolymer in layer 16, and 3 lbs. ethylene vinyl alcohol copolymer in layer 24. A second structure (NFHF B) consistent with the format of laminate 45 was produced using 5 lbs. nylon 6 in layer 54, 4 lbs. ethylene vinyl alcohol copolymer in layer 60, and 30 lbs. LDPE in layer 64. These structures along with the foil and NFCF structures used in the previous examples were hot filled with orange juice that had been processed at 190° F.

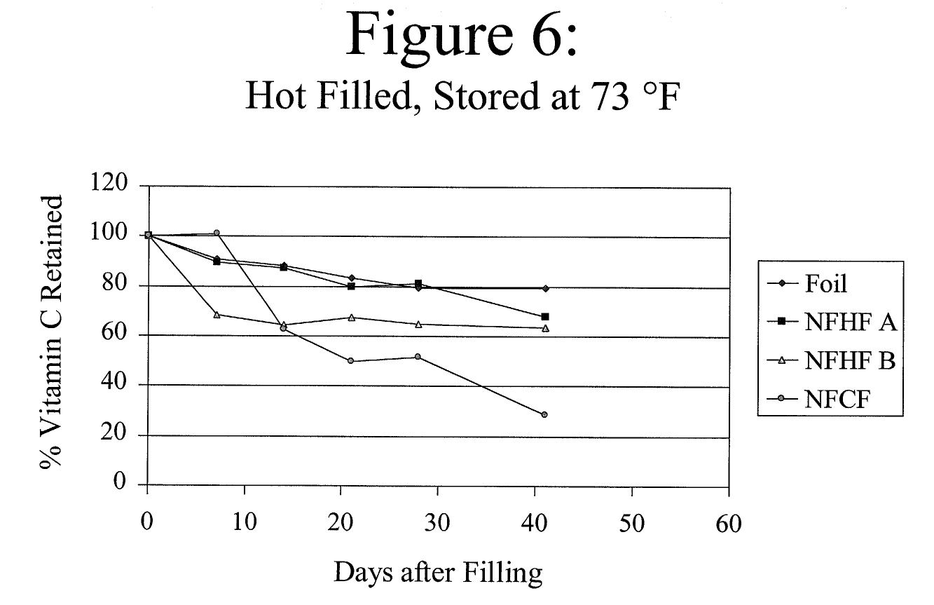

Vitamin C content was measured during filling and at days 7, 14, 21, 28, 41, 56, and 69 after filling. A plot of % vitamin C retained vs. days after filling is shown in FIG. 6. Vitamin C retention of the NFHF A structure was equivalent to the foil control after 69 days, while the overall vitamin C retention in NFHF B was 12% poorer than foil. The NFCF carton structure again performed the worst with a 52% greater vitamin C loss compared to foil at the end of the study.

### EXAMPLE 5

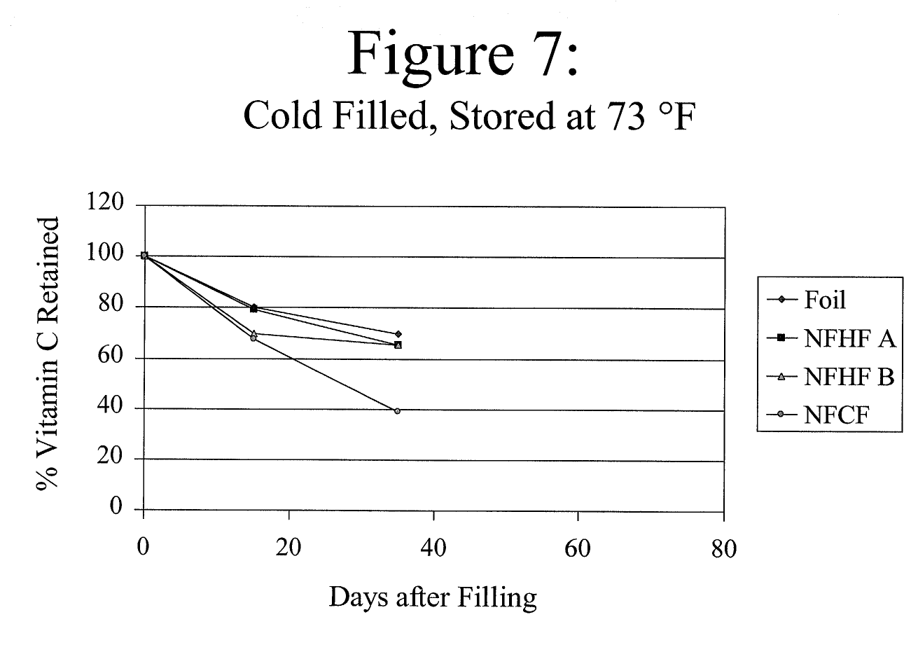

The four carton structures used in Example 4 were also cold filled with fresh orange juice and stored at room temperature (73° F.) for 56 days. Vitamin C content was measured during filling and at days 15, 35, and 56 after filling. A plot of % vitamin C retained vs. days after filling is shown in FIG. 7 establishing that the NFHF A and B structures performed equivalently to the foil control and significantly better than the NFCF carton structure.

### EXAMPLE 6

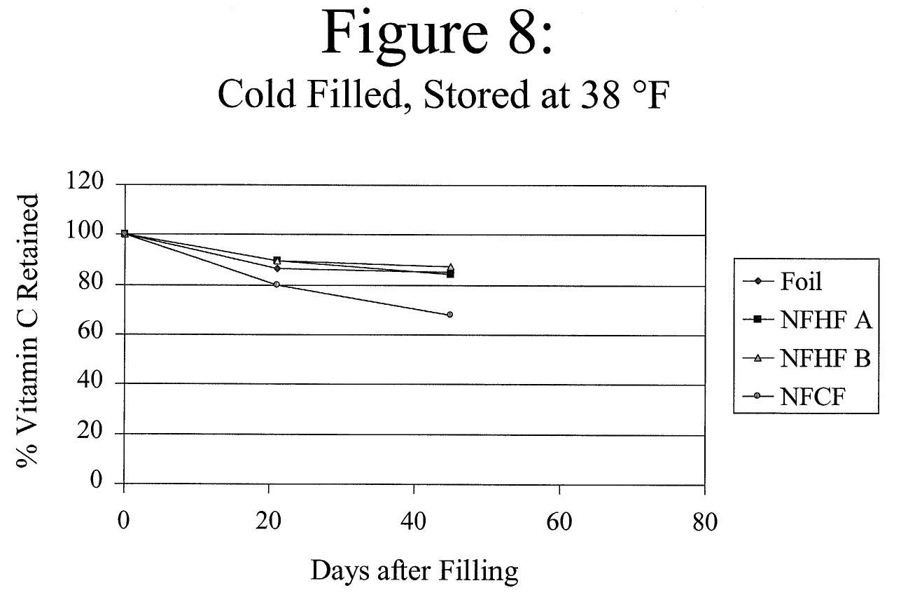

The four carton structures of Example 4 were also cold filled with fresh orange juice and stored at refrigerated conditions (38° F.) for 63 days. Vitamin C content was measured during filling and at days 21, 45, and 63 after filling. A plot of % vitamin C retained vs. days after filling is shown in FIG. 8. Once again, vitamin C retention in the NFHF A structure was equivalent to foil. NFHF B was comparable to foil through 45 days then showed a drop in vitamin C at day 63. Vitamin C retention in the NFCF structure was about 17% poorer than foil after 63 days.

We claim:

1. An oxygen barrier laminate for producing a container comprising from the outer surface to the inner surface contacting the container's contents:
a) a paperboard substrate having an exterior and an interior surface;
b) a first layer of polyolefin coated on said exterior surface of said paperboard substrate;
c) a layer of polyamide applied onto said interior surface of said paperboard substrate;
d) a second and innermost layer of polyolefin that will contact the contents of the container; and
e) at least one oxygen barrier layer of EVOH provided intermediate said polyamide layer and said innermost layer of polyolefin.

2. An oxygen barrier laminate according to claim 1 wherein said at least one layer of EVOH is applied directly overlying and in contact with said polyamide layer.

3. An oxygen barrier laminate according to claim 2 wherein there is a second layer of EVOH which is provided intermediate said first EVOH layer and said innermost polyolefin layer.

4. An oxygen barrier laminate according to claim 2 wherein there is an additional barrier layer selected from the group consisting of PVOH, polyamides, polyester terephthalates, polyolefins, polycarbonates, liquid crystal polymers and blends of any of the foregoing, and blends of any of the foregoing with at least one member selected from the group consisting of desiccants, molecular sieves, and cyclodextrins, which is provided intermediate said first EVOH layer and said innermost polyolefin layer.

5. The oxygen barrier laminate according to claim 3 wherein a layer of polyolefin is provided intermediate said first and second EVOH layers.

6. An oxygen barrier laminate according to claim 2 wherein a tie layer is applied directly onto said first EVOH layer.

7. An oxygen barrier laminate according to claim 5 wherein a tie layer is applied directly onto said first EVOH layer, said layer of polyolefin is provided directly over said tie layer and a second tie layer is applied directly onto said polyolefin layer.

8. An oxygen barrier laminate according to claim 7 wherein said second EVOH layer is applied directly onto said second tie layer.

9. An oxygen barrier laminate according to claim 8 wherein a third tie layer is applied onto said second EVOH layer and contacts said innermost polyolefin layer.

10. An oxygen barrier laminate according to claim 4 wherein a tie layer is applied directly onto said first EVOH layer, a layer of polyolefin is provided over said tie layer, a second tie layer is applied directly onto said polyolefin layer and said additional barrier layer is applied directly onto said second tie layer.

11. An oxygen barrier laminate according to claim 10 wherein a third tie layer is applied directly onto said additional barrier layer and contacts said innermost layer of polyolefin.

12. An oxygen barrier laminate for producing a container comprising from the outer surface to the inner surface contacting the container's contents:
a) a paperboard substrate having an interior and an exterior surface;
b) a first layer of polyolefin coated on said exterior surface of said paperboard substrate;
c) a layer of polyamide applied onto said interior surface of said paperboard substrate;
d) a first layer of EVOH applied onto said polyamide layer;
e) a first tie layer applied onto said EVOH layer;
f) a layer of polyolefin applied directly onto said first tie layer;
g) a second tie layer applied directly onto said polyolefin layer;
h) a second layer of EVOH applied directly onto said second tie layer;
i) a third tie layer applied directly onto said second EVOH layer; and
j) a layer of polyolefin applied directly onto said third tie layer, said layer of polyolefin being the innermost layer that contacts the container's contents.

13. An oxygen barrier laminate according to claim 1 wherein there is one layer of EVOH, at least one tie layer applied onto said polyamide layer and said EVOH layer is applied directly overlying and in contact with said at least one said tie layer.

14. An oxygen barrier laminate according to claim 13 wherein there are two tie layers applied sequentially onto said polyamide layer and said EVOH layer is applied directly overlying and in contact with the second of said tie layers.

15. An oxygen barrier laminate according to claim 13 wherein a third tie layer is applied intermediate said EVOH layer and said innermost layer of polyolefin.

16. An oxygen barrier laminate for producing a container comprising from the outer surface to the inner surface contacting the container's contents:
a) a paperboard substrate having an interior and an exterior surface,
b) a first layer of polyolefin coated on said exterior surface of said paperboard substrate,
c) a layer of polyamide applied onto said interior surface of said paperboard substrate,
d) two tie layers applied sequentially onto said polyamide layer,
e) a layer of EVOH applied directly overlying and in contact with the second of said tie layers,
f) a third tie layer applied directly onto said EVOH layer, and
g) a layer of polyolefin applied over said third tie layer, said layer of polyolefin being the innermost layer that contacts the container's contents.

17. An oxygen barrier laminate for producing a container comprising from the outer surface to the inner surface contacting the container's contents:
a) paperboard substrate having an interior and an exterior surface,
b) a first layer of polyolefin coated on said exterior surface of said paper board substrate,
c) a layer of polyamide applied onto said interior surface of said paperboard substrate,
d) a first tie layer applied onto said polyamide layer,
e) a layer of EVOH applied directly overlying and in contact with said first tie layer,
f) a second tie layer applied directly onto said EVOH layer, and
g) a layer of polyolefin applied over said second tie layer, said layer of polyolefin being the innermost layer that contacts the container's contents.

18. A method for extending the shelf life of a citrus juice stored in a paperboard container wherein said container is formed from a laminate according to claim 1.

19. A method for extending the shelf life of a citrus juice stored in a paperboard container wherein said container is formed from a laminate according to claim 12.

20. A method for extending the shelf life of a citrus juice stored in a paperboard container wherein said container is formed from a laminate according to claim 16.

21. A method for extending the shelf life of a citrus juice stored in a paperboard container wherein said container is formed from a laminate according to claim 17.

22. A sealed container and a perishable product contained therein, the container being constructed of a laminate according to claim 1, the product being hot filled into the container, said product having been heated to a temperature sufficient to kill essentially all the microorganisms in the food product, sealing the container and cooling the product within the container to ensure that the product is shelf stable.

23. A container blank constructed from a laminate according to claim 1.

24. A container blank constructed from a laminate according to claim 12.

25. A container blank constructed from a laminate according to claim 16.

27. A container blank constructed from a laminate according to claim 17. A container constructed from a laminate according to claim 1.

28. A container constructed from a laminate according to claim 12.

29. A container constructed from a laminate according to claim 16.

30. A container constructed from a laminate according to claim 17.

31. A method for extending the shelf life of a citrus juice stored in a paperboard container including the step of forming the container from a laminate according to claim 1.

32. A laminated packaging material especially for heat-sealable hot fill, room temperature storage liquid food packages comprising an oxygen barrier laminate according to claim 1.

33. A laminated packaging material especially for heat sealable cold fill, room temperature storage comprising an oxygen barrier laminate according to claim 1.

34. A laminated packaging material especially for heat sealable, cold fill, refrigerated storage comprising an oxygen barrier laminate according to claim 1.
